(19) United States
(12) Patent Application Publication
(10) Pub. No.: US 2009/0309704 A1
(43) Pub. Date: Dec. 17, 2009

(54) Methods and Systems for RFID Reader Power Management

(75) Inventors: Tong-Hsiao Chang, Westbury, NY (US); Karl Edward Keppeler, Bellport, NY (US); Charles Rinkes, Medina, OH (US)

Correspondence Address: MOTOROLA, INC., 1303 EAST ALGONQUIN ROAD, IL01/3RD, SCHAUMBURG, IL, 60196, US

(73) Assignee: Symbol Technologies, Inc., Holtsville, NY (US)

(21) Appl. No.: 12/137,370

(22) Filed: Jun. 11, 2008

(51) Int. Cl. H04Q 5/22

(52) U.S. Cl. 340/10.1

(57) ABSTRACT

Methods, systems, and apparatuses for managing power consumed by an RFID reader are described. Such methods, systems and apparatuses can include, for example, controlling RFID reader power levels by detecting proximity to an RFID tagged object, by motion detection of RFID readers and tags. Using internal and/or external sensor modules, power management capabilities of the RFID reader are enhanced leading to less frequent recharging of the RFID reader.

### BACKGROUND OF THE INVENTION

1. Field of the Invention

The invention relates to radio frequency identification (RFID) reader technology, and in particular, to a system and method to manage and reduce power consumption of an RFID device, such as a mobile RFID reader, for example.

2. Background Art

Conventional RFID readers are designed to read tags continuously during any tag data acquisition operation. This leads to a higher power consumption by the RFID reader which is detrimental in attaining sustainable operation time, such as for an 8 hour shift. In a mobile RFID reader, the overall power consumption can reach up to 1 W. In some applications, such as a forklift in a warehouse, an RFID reader needs to read RFID tags when it detects that a desired object (on which an RFID tag is resident) is in range or field of view of RFID reader's antenna so that accurate information about the object can be ascertained. In such applications, using a conventional constant power continuously operating RFID reader does not optimize power consumption by the RFID reader. This results in a faster discharge of RFID reader batteries and subsequent frequent interruptions in normal operation of the RFID reader. Further, without a capability to vary output power levels of an RFID reader antenna, the RFID reader can incur misses in reading some RFID tagged objects that move out of range, if the RFID reader is not at its maximum output power level. Conventional RFID readers lack any form of power variation, or optimization of power consumption.

In other applications, tracking RFID devices and/or inventory item(s) requires intermittent activation of RFID reader so that the RFID reader does not consume unnecessary power when no such devices are present. For example, when a forklift on which the RFID reader resides comes to a rest and stops any inventory operation, there is no real need to keep the RFID reader ON. Furthermore, when the forklift reads a tag coupled to a object on the forklift, there is no need for the RFID reader to continually read the tag while the object remains on the forklift. That is, once a box is on a forklift, the box is not going to suddenly become a different box. The box must be dropped off by the forklift and a different box picked up for the tag data to change. Continually reading a tag while the same box is on a forklift is an inefficient use of reader battery power.

Current solutions to optimize reader power require manual intervention by a user to turn ON or turn OFF the RFID reader, or use a timer to activate or de-activate the RFID reader. Both the current solutions are wasteful in terms of power consumption. For example, in an RFID reader controlled by a timer, power may still be consumed if the forklift has completed inventory operations and come to a rest before the timer has reset. Therefore a lack of any form of motion detection to determine whether or not a forklift is operating in an inventory read operation leads to a waste in valuable battery capacity of the RFID reader and necessitates frequent recharge operations thereby disrupting normal inventory operations. In scenarios where RFID tags are moving (e.g., on a conveyor belt), conventional RFID readers are left continuously ON between detection of two successive tags, also leading to a waste of RFID reader battery and power resources.

Thus, what is needed are intelligent techniques and systems to control and manage RFID reader power levels, thereby increasing the time of operation of RFID readers without frequent recharge of batteries. What is also needed are techniques that avoid incorrect reads due to an RFID tagged object fading out of RFID reader field of view.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an exemplary environment in which RFID readers communicate with an exemplary population of RFID tags.

FIG. 2 illustrates a diagram where an RFID reader installed on a forklift performs power-efficient inventory operation in an exemplary warehouse scenario.

FIG. 3 illustrates an RFID reader with a proximity sensor residing on it.

FIGS. 4A and 4B illustrate details of an RFID reader circuitry along with an inbuilt sensor module and an external sensor module, respectively.

FIG. 5 illustrates an exemplary RFID reader communication with an external sensor module via a Central Management System (CMS).

FIGS. 6A-B illustrates plots of RFID reader antenna power levels as a function of distance from an RFID tagged object.

FIG. 7 illustrates a flowchart for power management of an RFID reader, according to one embodiment of the present invention.

FIG. 8 illustrates an RFID reader with motion detection capability.

FIGS. 9 illustrate a flowchart showing RFID reader power management using motion detection.

FIG. 10 illustrates an exemplary computer system used to control power management of an RFID reader.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### 1.0 Introduction

Methods, systems, and apparatuses for RFID devices are described herein. In particular, methods, systems, and apparatuses for managing power levels of an RFID reader without manual intervention are described. Such methods systems, and apparatuses also increase battery life and time between recharging an RFID reader.

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

### 2.0 Example RFID Environment

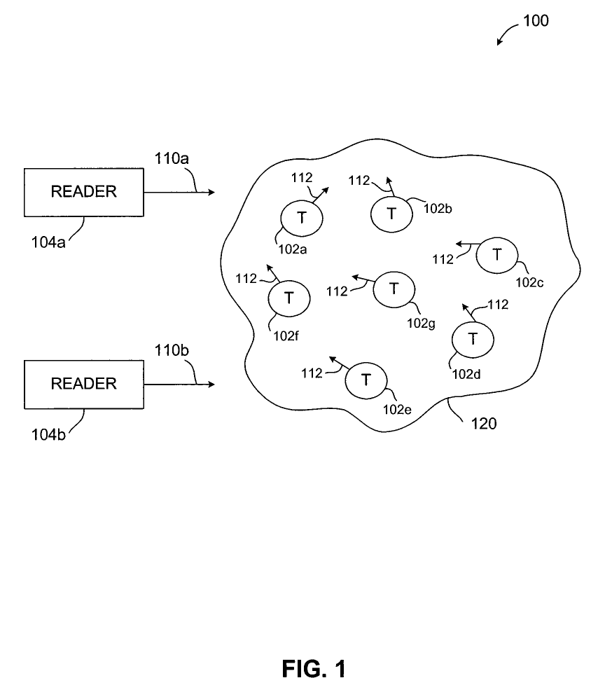

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. A population 120 may include any number of tags 102. Environment 100 includes any number of one or more readers 104. For example, environment 100 includes a first reader 104a and a second reader 104b (also interchangeably referred to herein as a single RFID reader 104). Readers 104a and/or 104b may be requested by an external application to address the population of tags 120. Alternatively, reader 104a and/or reader 104b may have internal logic that initiates communication, or may have a trigger mechanism (for example, an ON/OFF trigger) that an operator or a central controller of RFID reader 104 uses to initiate communication. Readers 104a and 104b may also communicate with each other in a reader network.

As shown in FIG. 1, reader 104a transmits an interrogation signal 110a having a carrier frequency to the population of tags 120. Reader 104b transmits an interrogation signal 110b having a carrier frequency to the population of tags 120. Each such transmission of an interrogation signal by the RFID readers 104a and b consumes power. By practice of this invention, power consumption of RFID readers 104a and b is reduced. In addition, the ability to vary power levels of RFID readers 104a and b aids in avoiding tag misses and/or redundant tag reads.

Readers 104a and 104b typically operate in one or more of the frequency bands allotted for this type of RF communication. For example, frequency bands of 902-928 MHz and 2400-2483.5 MHz have been defined for certain RFID applications by the Federal Communication Commission (FCC).

### 3.0 Example Embodiments

Automatic power management for RFID reader 104 can be performed in various ways.

One technique of power management is by use of a proximity sensor. In this scenario, RFID Reader 104 senses how spatially close an object on which an RFID tag resides, is to RFID reader 104. If and when the RFID tag or the RFID tagged object enters the field of view for RFID reader, select circuitry in RFID reader 104 is turned ON and data from RFID tag residing on the object is read. Subsequently, when the RFID tagged object moves out of the field of view, the proximity sensor sends control signal to turn select RFID reader 104 circuitry OFF. Using a proximity sensor allows RFID reader 104 to maximize its battery life and allows detection of RFID tags as they move in and out of RFID reader 104's range. Depending on specific applications, proximity sensing can be achieved by means of various proximity sensors such as capacitive, magnetic, inductive, reflective, photocell proximity sensors, laser rangefinders, active or passive sonar, radar, Doppler effect, passive thermal infrared, passive optical sensing (such as Charge Coupled Devices), image sensing, reflection of ionizing radiation, or other techniques well known to one skilled in the art.

In another embodiment, once an RFID reader 104 has read a tag coupled to an object in the field of view of the sensor, circuitry in the RFID reader 104 may be turned OFF until the object has left the field of view of the sensor, or another new tagged object enters RFID reader 104's field of view. In this embodiment, RFID can be enabled after a pre-determined time interval merely to confirm whether the object in the field of view is the same. The pre-determined time interval can be programmable depending upon specific applications.

RFID reader power management can also be accomplished by motion detection of RFID reader 104 and/or RFID tags. Additionally or alternatively, RFID reader 104 power can also be managed by detecting motion of RFID tagged objects, for example, RFID tagged objects on a conveyer belt at a checkout point in a supermarket. According to this embodiment of the present invention, RFID reader 104 is activated only when motion is detected. Using motion detecting devices well known to those skilled in the art, RFID reader 104 can be triggered either in a continuous or a pulsed mode of operation when either RFID reader 104 or RFID tag motion is detected. Subsequently, tag data acquisition is performed and when motion has ceased, select circuitry in RFID reader 104 is de-activated. Such an automated solution for power management of RFID reader 104 requires no manual intervention, and significantly increases battery life in RFID devices employing tracking application(s).

Motion detection can be accomplished using an accelerometer, for example. Such an accelerometer can be installed as part of RFID reader 104, for example, on a forklift operating in a warehouse. Exemplary motion detection techniques include passive infrared sensors, ultrasonic sensors, microwave sensors, a combination of these, or other motion detection techniques well known to one skilled in the art.

These exemplary embodiments are described in detail below. It should be noted that one skilled in the art, after reading this disclosure, can contemplate other such techniques and systems where RFID reader 104 can be operated at varying power levels to reduce power consumption and improve accuracy of tag reads. Additionally or alternatively, though a single RFID reader 104 and a single detector/sensor (proximity sensor and/or motion detector, or any other form of detector) is described, one skilled in the art, after reading this disclosure, can easily extend the ideas embodied in this invention to multiple RFID readers and sensors, such as an array of RFID readers and an array of sensors, for example. It is also to be noted that the two exemplary techniques described above, can be combined in one or more ways to conserve battery life of RFID reader 104, as can also be contemplated by those skilled in the art, after reading this disclosure.

### 3.1 Proximity Sensing

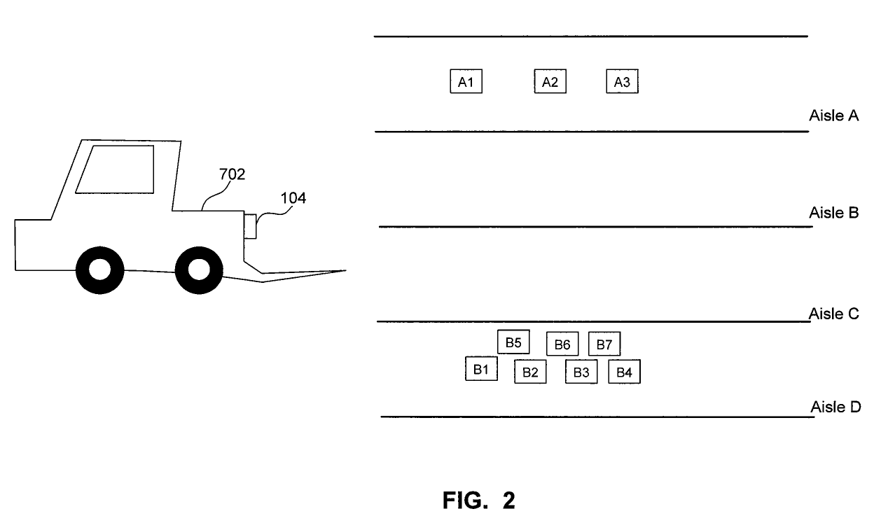

FIG. 2 depicts an exemplary operating environment 200 for reader power management via proximity sensing, according to embodiments of the present invention. Operating environment 200 represents a warehouse having multiple aisles. A subset of the aisles (e.g., aisles A and D) in the warehouse contains tagged items (A1-A3 and B1-B7) to be inventoried. In this exemplary environment, inventory operations are conducted by the RFID reader 104 installed on a forklift 202. As shown in FIG. 2, forklift 202 may traverse spaces within the warehouse (e.g., from dock door to aisles or between aisles) having no items to be inventoried.

In conventional inventory operations, RFID reader 104 is turned ON and operating at maximum power as soon as forklift 202 operation begins, irrespective of whether forklift 202 is in the proximity of any items to be inventoried. This leads to a waste of battery power in RFID reader 104. According to one embodiment of the present invention, battery power of RFID reader 104 can be managed in an intelligent way, by turning RFID reader 104 on only when forklift 202 is close to some of the RFID tags (or has just picked up a new item to be inventoried). When operation begins, RFID reader 104 is at a low power state or all or a subset of reader circuitry is turned OFF. As forklift 202 approaches aisle A, RFID reader 104 may turn on selective circuitry or increase the power level based on the proximity to the aisle and perform a read of tagged objects/items A1-A3. When forklift 202 is not near any RFID tagged object, RFID reader 104 turns OFF all or a subset of circuitry or reduces power to a minimum level (e.g., between aisles B and C), thereby saving its battery. As forklift approaches aisle D, RFID reader 104 is turned ON again to perform a read of tagged items B1-B7. Thus, by selectively turning RFID reader 104 ON or OFF (or by dynamically altering output level) as forklift 202 (and reader 104) moves through various aisles of a warehouse, RFID reader 104 battery power can be conserved. Alternatively or additionally, circuitry in RFID reader 104 can also be turned OFF after a tag read has finished and is kept OFF until the object leaves the field of view of the sensor and an object reenters the field of view of the sensor. If the object does not leave the field of view of the sensor, circuitry within RFID reader 104 can be activated, after a preset time interval, to determine whether it is the same tagged object. Such a procedure also conserves battery power for a reader.

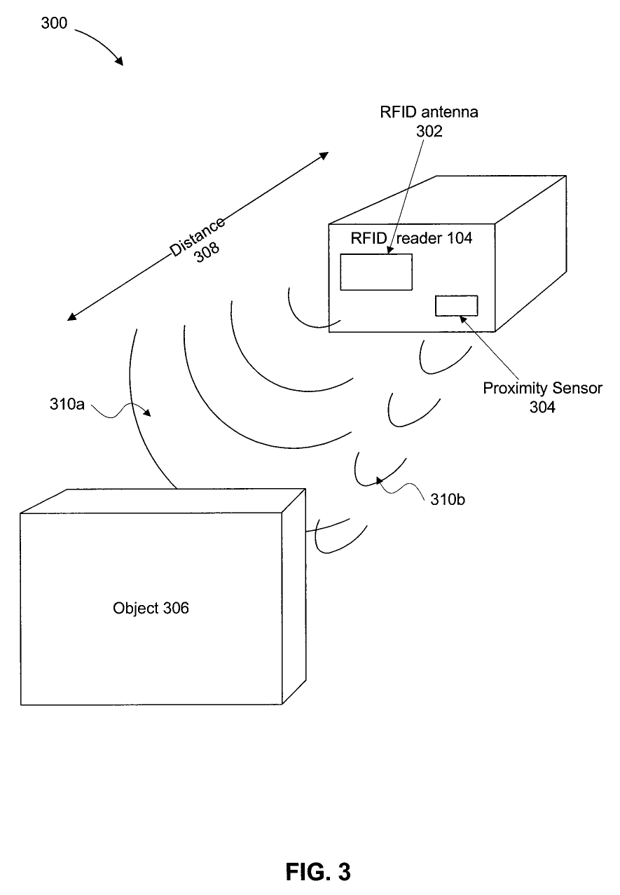

FIG. 3 illustrates another exemplary operating environment 300 for reader power management via proximity sensing, according to embodiments of the invention. In environment 300, RFID reader 104 includes a proximity sensor 304. Also shown residing on RFID reader 104 is an RFID antenna 302 that transmits and/or receives electromagnetic radiation 310a to or from object 306 which is at a distance 308 from RFID reader 104. During operation, proximity sensor 304 detects the presence of object 306 in the field of view of reader 104. This can be done, for example, by emitting electromagnetic radiations 310b at a frequency such that object 306 reflects back those electromagnetic radiations to proximity sensor 304 thereby indicating its presence. Proximity sensing can also be realized using an image sensor (not shown in FIG. 3) that detects a presence of an RFID tagged object by detecting ambient light reflected off the RFID tagged object. Proximity sensor 304 communicates the presence of an object (and optionally data that can be used to determine the relative location of the object from reader 104) to reader 104. Reader 104 then turns on all or a subset of its circuitry or alternatively increases its output power to a level suitable to read a tag disposed on object 306. Alternatively or additionally, proximity sensing for power control of RFID reader 104 can also be utilized when the RFID tagged object has entered the proximity sensor's field of view (e.g., when a tagged object is picked up by forklift 202). In such a scenario, RFID reader 104 reads tag data on the RFID tagged object and then RFID reader 104 circuitry is turned OFF. In an embodiment, reader circuitry remains off until the object leaves the field of view and an object reenters. Additionally or alternatively, after a pre-determined time interval that an object remains in the field of view, RFID reader 104 circuitry may be turned ON to determine whether the same object is in the field of view RFID reader 104 or a new tagged object has come in. If it is the same tagged object as in a previous read, RFID reader 104 circuitry is turned OFF.

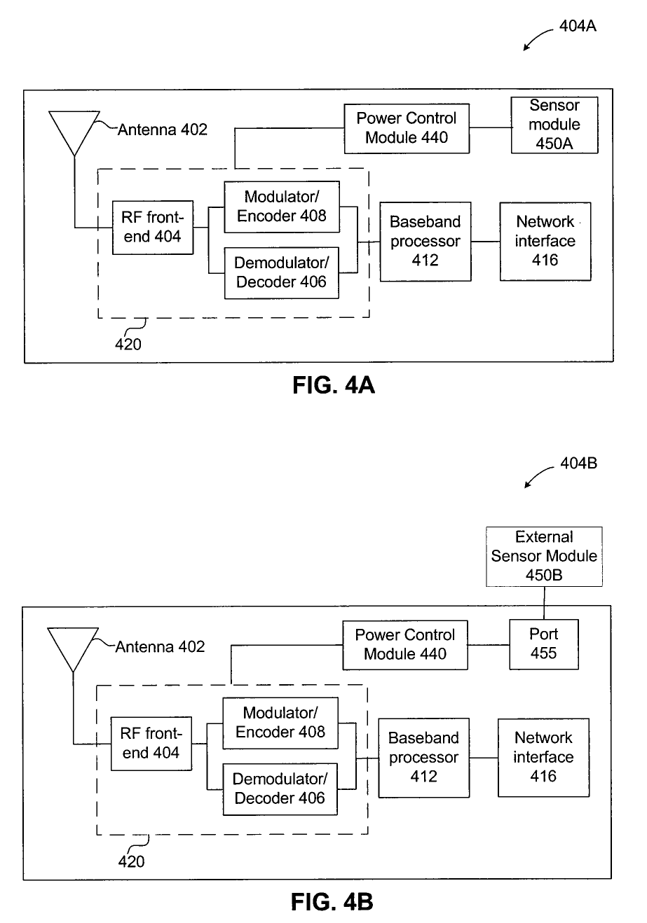

FIG. 4A shows a block diagram of an example RFID reader 404, according to embodiments of the present invention. Reader 404A includes one or more antennas 402, a receiver and transmitter portion 420 (also referred to as transceiver 420), a baseband processor 412, a network interface 416, a power control module 440, and a sensor module 430. These components of reader 404A may include software, hardware, and/or firmware, or any combination thereof, for performing their functions.

Baseband processor 412 and network interface 416 are optionally present in reader 404A. Baseband processor 412 may be present in reader 404A, or may be located remote from reader 404A. For example, in an embodiment, network interface 416 may be present in reader 404A, to communicate between transceiver portion 420 and a remote server that includes baseband processor 412. When baseband processor 412 is present in reader 404A, network interface 416 may be optionally present to communicate between baseband processor 412 and a remote server. In another embodiment, network interface 416 is not present in reader 404A.

In an embodiment, reader 404A includes network interface 416 to interface reader 404A with a communications network (not shown). As shown in FIG. 4A, baseband processor 412 and network interface 416 communicate with each other via a communication link 422. Network interface 416 is used to provide an interrogation request to transceiver portion 420 (optionally through baseband processor 412), which may be received from a remote server coupled to the communications network. Baseband processor 412 optionally processes the data of the interrogation request prior to being sent to transceiver portion 420. Transceiver 420 transmits the interrogation request via antenna 402.

Reader 404A has at least one antenna 402 for communicating with tags 102 and/or other readers 404A. Antenna(s) 402 may be any type of reader antenna known to persons skilled in the relevant art(s), including a vertical, dipole, loop, Yagi-Uda, slot, or patch antenna type.

Transceiver 420 receives a tag response via antenna 402. Transceiver 420 outputs a decoded data signal generated from the tag response. Network interface 416 is used to transmit decoded data signal received from transceiver portion 420 (optionally through baseband processor 412) to a remote server coupled to communications network. Baseband processor 412 optionally processes the data of decoded data signal prior to being sent over communications network.

In embodiments, network interface 416 enables a wired and/or wireless connection with the communications network. For example, network interface 416 may enable a wireless local area network (WLAN) link (including a IEEE 802.11 WLAN standard link), a BLUETOOTH link, and/or other types of wireless communication links. The communications network may be a local area network (LAN), a wide area network (WAN) (e.g., the Internet), and/or a personal area network (PAN).

In embodiments, a variety of mechanisms may be used to initiate an interrogation request by reader 404A. For example, an interrogation request may be initiated by a remote computer system/server that communicates with reader 404A over the communications network. Alternatively, reader 404A may include a finger-trigger mechanism, a keyboard, a graphical user interface (GUI), and/or a voice activated mechanism with which a user of reader 104 may interact to initiate an interrogation by reader 404A.

In the example of FIG. 4A, transceiver portion 420 includes a RF front-end 404, a demodulator/decoder 406, and a modulator/encoder 408. These components of transceiver 420 may include software, hardware, and/or firmware, or any combination thereof, for performing their functions. Example description of these components is provided as follows.

Modulator/encoder 408 receives an interrogation request, and is coupled to an input of RF front-end 404. Modulator/encoder 408 encodes interrogation request into a signal format, such as one of pulse-interval encoding (PIE), FM0, or Miller encoding formats, modulates the encoded signal, and outputs the modulated encoded interrogation signal to RF front-end 404.

RF front-end 404 may include one or more antenna matching elements, amplifiers, filters, an echo-cancellation unit, a down-converter, and/or an up-converter. RF front-end 404 receives a modulated encoded interrogation signal from modulator/encoder 408, up-converts (if necessary) the interrogation signal, and transmits the interrogation signal to antenna 402 to be radiated. Furthermore, RF front-end 404 receives a tag response signal through antenna 402 and down-converts (if necessary) the response signal to a frequency range amenable to further signal processing.

Demodulator/decoder 406 is coupled to an output of RF front-end 404, receiving a modulated tag response signal from RF front-end 404. In an EPC Gen 2 protocol environment, for example, the received modulated tag response signal may have been modulated according to amplitude shift keying (ASK) or phase shift keying (PSK) modulation techniques. Demodulator/decoder 406 demodulates the tag response signal. For example, the tag response signal may include backscattered data formatted according to FM0 or Miller encoding formats in an EPC Gen 2 embodiment. Demodulator/decoder 406 outputs decoded data signal 414.

The configuration of transceiver 420 shown in FIG. 4A is provided for purposes of illustration, and is not intended to be limiting. Transceiver 420 may be configured in numerous ways to modulate, transmit, receive, and demodulate RFID communication signals, as would be known to persons skilled in the relevant art(s).

Sensor module 450 is configured to detect the presence of an object and/or an RFID tag. Sensor module 450 is further configured to indicate to power control module 440 that an object and/or tag was detected. In an embodiment, sensor module 450 provides additional data to power control module 440.

Power control module 440 is configured to turn on or off select circuitry or modify output power of reader 404A upon detection of an object and/or tag. Power control module 440 may further be configured to adjust power level of the reader 440 based on data received from sensor module 450. For example, if power control module 440 receives data indicating reader 404A has moved closer to objects being inventoried, reader 404A may lower power level being used by reader 404A. Such an adjustment can be implemented by software or hardware means, or by an appropriate combination of both. Power control module 440 is coupled to transceiver 420 and optionally to baseband processor 412.

FIG. 4B shows an alternative block diagram of an example RFID reader 404B, according to embodiments of the present invention. As shown in FIG. 4B, RFID reader 404B has an external sensor module 450B which can be connected to RFID reader 104 via a port 455 or similar connection mechanism. For example, external sensor 450B may be a plug-in sensor module. The functions of external sensor module 450B are substantially similar to sensor module 450 of FIG. 4A. The embodiment of FIG. 4B is particularly useful in making conventional RFID readers that don't have any form of proximity detection, motion detection, or position detection capabilities, adaptable to utilize various embodiments of the present invention. In addition, by having an external capability, RFID reader 404B can adapt to customized sensor modules and will not be restricted to a particular type of sensor. Additionally or alternatively, external sensor module 450B can be an integrated sensor module including different types of sensors, or arrays of different types of sensors.

In an embodiment, when external sensor module 450B is connected to RFID reader 404B (e.g., via port 455), RFID reader 404B will operate as if external sensor module 450B was a part of its overall circuitry. Port 455 can be, for example, a bi-directional port. Port 455 is coupled to power control module 440. Further, by means of port 455, RFID reader 404B can also communicate and/or receive sensor data from a plurality of sensor modules similar to plug-in sensor module 450B. Further still, RFID reader 404B can communicate with one or more external sensor modules similar to plug-in sensor module 450B without use of a port 455. For example, RFID reader 404B can have an additional antenna to communicate with external sensor module. Such an antenna can replace port 455 in communicating with power control module 440.

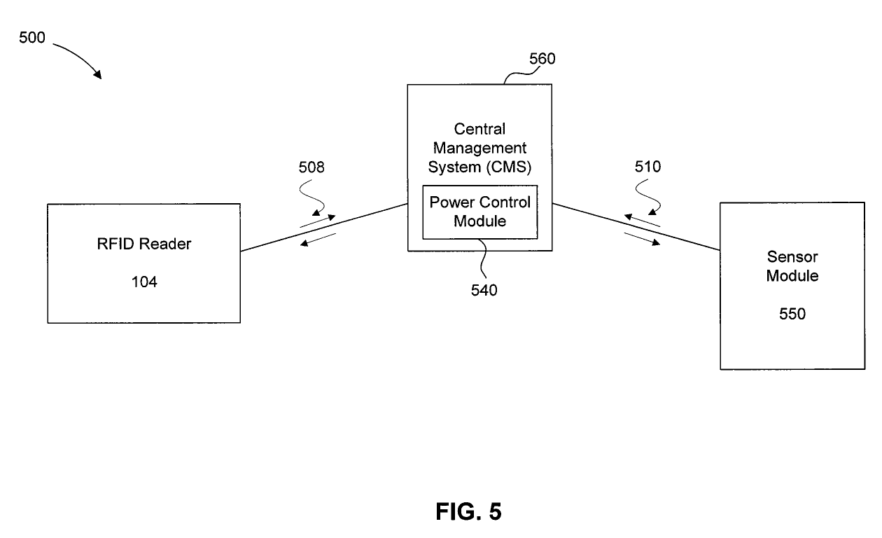

FIG. 5 depicts an exemplary system 500 for optimizing power consumption of an RFID reader via proximity sensing, according to embodiments of the present invention. In exemplary system 500, RFID reader 104 and an external sensor module 550 communicate with each other via a central management system (CMS) 560. Such a communication takes place through signals 508 and 510.

Sensor module 550 was described above in reference to FIGS. 4A and 4B and can be integrated with RFID reader 104 or can be external to RFID reader 104. Although a single RFID reader 104 and a single external sensor module 550 are depicted in FIG. 5, one skilled in the art can easily contemplate that system 500 may include multiple sensors and RFID readers. CMS 560 is configured to control operations of one or more external sensor modules 550 and one or more RFID readers 104. In an embodiment, CMS 560 includes a power control module 540. Power control module 540 receives data from one or more sensors and determines whether to activate or deactivate circuitry within a reader and/or determines the optimal power level for a reader. Because CMS 560 receives data from multiple RFID readers 104 and sensor modules 550, CMS 560 can make adjustments on a system level, across multiple readers, to achieve maximum power consumption and read efficiency for the system. For example, power levels of corresponding antennas residing on RFID readers similar to RFID reader 104 can be varied and redundant multiple tag reads can be avoided. CMS 560 can be, for example, one or more computer systems responsible for controlling operations of RFID reader 104. In typical scenarios, sensor module 550 and RFID reader 104 are spatially close to each other.

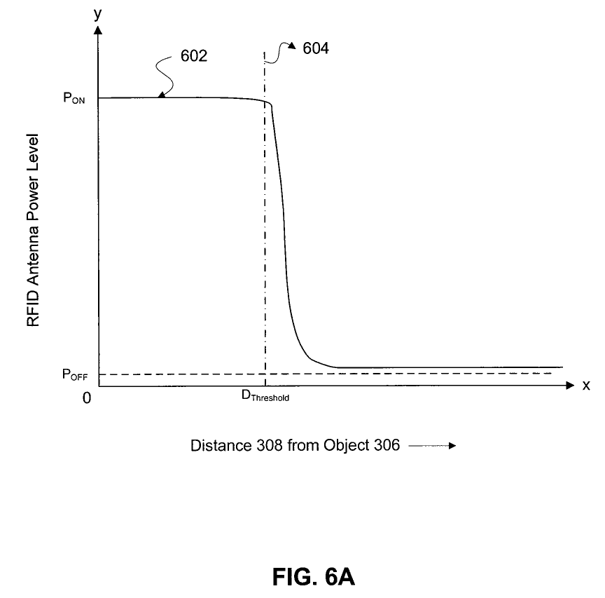

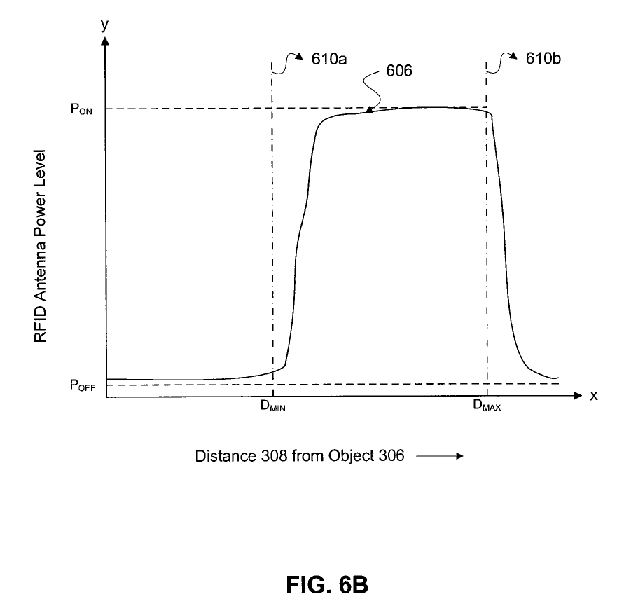

As described above, power control module 540 may turn reader circuitry ON or OFF or vary the output power of a reader based on distance from an object. FIG. 6A shows an exemplary plot of RFID antenna power level versus distance of a tagged object from RFID reader 104, according to embodiments of the invention. As shown in plot of FIG. 6A, RFID reader 104 is initially in an ON state and is reading information from a tag population including the tag residing on object. After a threshold distance between object and reader is reached, for example, D_{Threshold} 604, RFID reader 104 output power level is reduced or circuitry within reader 104 may start to be selectively deactivated. As distance increases, RFID output power level can be turned to a minimal level shown as P_{Off} or circuitry within reader 104 may be deactivated. As also described above, power control module 540 may turn reader circuitry OFF after an object comes into view of the sensor until the object leaves and an object reenters.

FIG. 6B illustrates another exemplary plot of RFID antenna power level versus distance of a tagged object from RFID reader 104, according to embodiments of the invention. For example, circuitry in a reader may be activated only when reader 104 is within a range of distances, Dₘᵢₙ to Dₘₐₓ, (shown by lines 610a to 610b, also referred to as a “distance window”) from the an object. As soon as the reader 104 enters the distance window, circuitry within RFID reader 104 is activated. The decision about whether the object is inside or out of range of RFID reader 104 is made, for example, by a proximity sensor module and/or by a power control module. RFID reader output power level stays at P_{ON} level as shown by line 606, and does not start falling to an “OFF” power level (P_{OFF}) until reader 104 moves to a distance outside the distance window maximum, distance Dₘₐₓ, as shown by line 610b. Therefore, by activating reader circuitry only a certain time when reader 104 is inside the distance window of the object, RFID reader 104 power consumption is reduced.

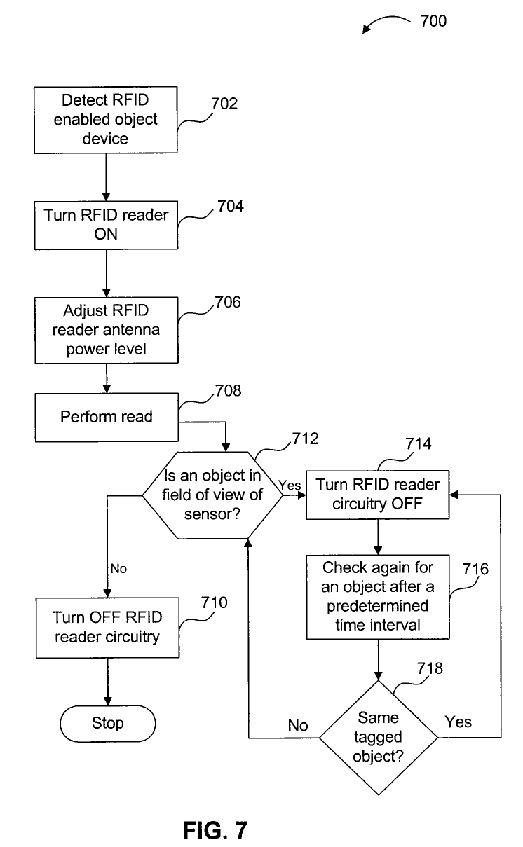

FIG. 7 illustrates a generic flowchart 700 of a method for dynamically managing power levels of RFID reader 104 in real-time without manual intervention using proximity sensing, according to various embodiments of the present invention. FIG. 7 is described with reference to the exemplary operating environments of FIGS. 1-5. However, flowchart 700 is not limited to those embodiments. Note that the steps of flowchart 700 do not necessarily have to occur in the order shown.

In step 702, the sensor module scans for an object or an RFID enabled device (an RFID tag, for example)in its vicinity or field of view. This can be done, for example, via a low power interrogation signal or a probe beam. If an object is detected, operation proceeds to step 704. If no object is detected, step 702 continues.

In addition to determining the presence of an object, sensor module (or power control module) may determine or estimate the current distance of the reader from the sensed tag or object. An object may be detected, for example, by receipt of a reflected probe beam or a response to the low power interrogation signal, among other methods. Distance may be estimated based on power levels of the received reflected beam or power level of response to the interrogation signal, for example.

In step 704, if one or more RFID tags or objects are detected, select circuitry within RFID reader 104 (e.g, transceiver 420) is turned on and/or the output power level is set at a preset level.

As described above, in an embodiment, RFID reader 104 includes power control module 440. In this embodiment, power control module 440 receives a signal from sensor module 450A indicating an object has been detected. Power control module 440 may also receive data indicating the distance between reader 104 and the object or data from which distance can be derived or estimated. Power control module 440 then activates circuitry within RFID reader 104 and/or adjusts the output power level of reader 104 based on this information.

When an external sensor module and central management system (CMS) is used (as depicted in FIG. 5), sensor module 550 communicates data to CMS 560 instead of directly to reader 104. In this embodiment, prior to step 704 CMS 560 establishes a communication link with RFID reader 104 and optionally the external sensor module. In an embodiment, one or more of these links is a secure communication link. Upon receiving communication from external sensor module 550 about the proximity of an object, power control module within CMS 560 communicates with RFID reader 104 to activate circuitry within the reader (e.g., turn reader “ON”) and/or alter the output power of the reader.

In step 706, the power control module (either within reader or at CMS) adjusts the output power level based upon information obtained in step 702 such as the spatial distance of the RFID tag(s) or objects from reader 104. This step is optional. For example, an RFID tag at a greater distance from reader 104 will require a higher power level to be read while an RFID tag at a shorter spatial distance from the reader will correspondingly require a lower power level. Depending upon the distance of the RFID tag, RFID reader 104 antenna power level is adjusted. The output power levels can be adjusted dynamically to yield optimal output value by means of various algorithms.

In step 708, reader 104 performs one or more reads of tags in the read range of reader 104. In an embodiment, during step 708, reader 104 may alter its power level based on proximity data received from the proximity sensor. For example, if RFID reader 104 moves closer to the tag population (or objects), reader 104 may decrease the output power.

In step 709, the proximity sensor checks whether an object is in its field of view. If no object is in the field of view, operation proceeds to step 710. If an object remains in the field of view of the sensor, operation proceeds to step 714.

In step 710, circuitry within RFID reader 104 circuitry (e.g., the transceiver) is turned OFF if an object is not detected within the field of view of RFID reader 104 for a predetermined period of time. This is advantageous, for example, when long duration operations of RFID reader 104 are desired and RFID reader 104's batteries need to be conserved. But for this automated on/off operation, RFID reader 104 will either remain continuously turned ON or would require manual operation to turn it ON or OFF, both of which are undesirable conditions. Operation then returns to step 702 during which the reader waits until a new object enters the field of view of the sensor.

In step 714, circuitry within RFID reader 104 is turned OFF.

In step 716, after a pre-determined period of time during which an object remains in the field of view of the sensor, RFID reader circuitry is turned ON and a tag read performed to determine whether the same tag or tags are in the field of view of reader 104.

In step 718, a determination is made whether the same tag or tags are in the field of view of the reader. If the tag(s) are the same, operation returns to step 714 where the RFID reader circuitry is turned off. If the tag(s) are different, operation returns to step 709. In this scenario, for example, a fork lift may have unloaded the first pallet and loaded a new pallet.

Steps 716 and 718 are optional.

An interval at which such a second confirmatory re-read can be performed is programmable, and is dependent on specific applications in which various embodiments of the invention can be used. For example, such an interval or time instance when a second read is performed can be determined when the forklift stops moving, possibly indicating that it is about to drop off the RFID tagged object.

### 3.2 Motion Detection

Power consumption of an RFID reader 104 may also be controlled and managed by detecting motion of RFID reader 104. This type of power management is useful in application in which the reader is mobile, for example, when RFID reader 104 is installed on forklift 202. In this example, the RFID reader is activated when movement of the reader is detected. In addition or alternatively, RFID power consumption can be managed by detecting the motion of objects within the field of view of reader 104. This can be useful, for example, in employee monitoring, or at a conveyor belt of a checkout facility in a convenience store.

Under conventional operation, a user would have to manually turn the reader ON or OFF to actually conserve power of an RFID reader 104. In other conventional operating environments without motion detection capabilities, RFID reader 104 is always kept turned ON at a preset level, leading to wasteful battery utilization. However, by use of a motion detector and power control logic, power management of RFID reader 104 is made possible by automatic activation/de-activation of RFID reader 104.

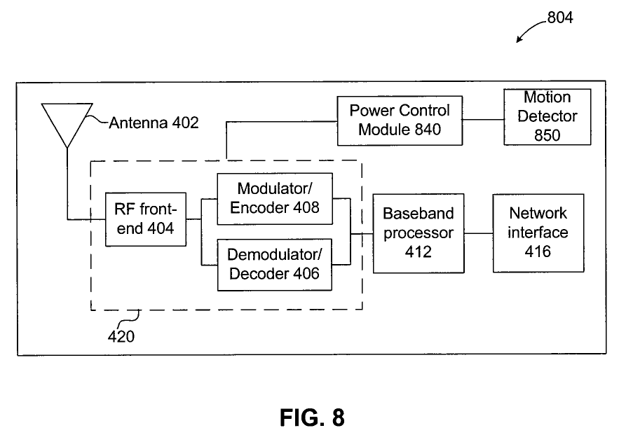

FIG. 8 depicts a block diagram of an example RFID reader 804, according to embodiments of the present invention. Reader 804 includes one or more antennas 402, a receiver and transmitter portion 420 (also referred to as transceiver 420), a baseband processor 412, a network interface 416, a power control module 840, and a motion detector 850. These components of reader 804 may include software, hardware, and/or firmware, or any combination thereof, for performing their functions. Antennas 402, transceiver 420, baseband processor 412, and network interface 416 are described above.

Motion detector 850 is configured to detect the motion of RFID reader 804. In addition or alternatively, motion detector 850 is configured to detect motion of objects within the field of view of RFID reader 804. Motion detector 850 is further configured to indicate to power control module 840 that motion was detected. In an embodiment, motion detector 850 includes an accelerometer. Motion detector 850 may be included in RFID reader 804 or may be an external module coupled to an RFID reader (not shown).

Power control module 840, coupled to motion detector 850, is configured to turn on select circuitry upon detection of motion. Power control module 840 may further be configured to deactivate select circuitry if movement has not been detected for a predefined period of time. Power control module 840 is also coupled to transceiver 420 and optionally to baseband processor 412.

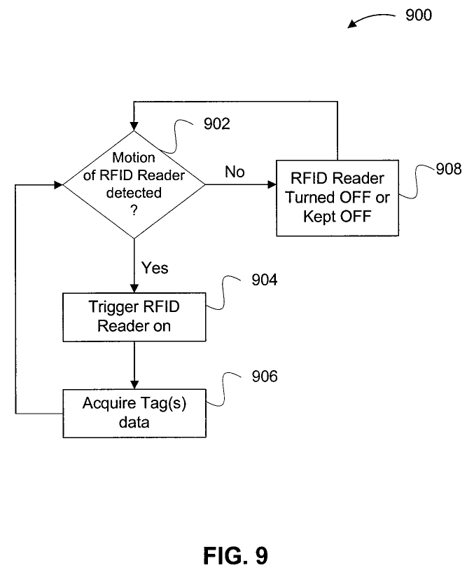

FIG. 9 depicts a flowchart 900 of an exemplary method for managing power consumption in an RFID reader via motion detection, according to embodiments of the present invention. Flowchart 900 is described with continued reference to the embodiment of FIG. 8. However, flowchart 900 is not limited to those embodiments. Note that the steps depicted in FIG. 9 do not necessarily have to occur in the order shown. Motion detection can occur at regular or random interval, depending upon specific needs.

In step 902, a determination is made whether motion of the RFID reader or an object within the field of view of RFID reader 804 has been detected. If motion has been detected, operation proceeds to step 904. If motion has not been detected, operation proceeds to step 908.

In step 904, if RFID 804 reader is currently in an “OFF” state, circuitry within RFID reader 804 is activated to turn the reader “ON.” If RFID reader 804 is currently in an “ON” state, power control module 840 maintains the current reader status.

In step 906, reader 804 performs on or more read cycles of the tag population.

In step 908, if the reader is currently in an “OFF” state, power control module 840 maintains the current reader status. However, if RFID reader 804 is currently in an “ON” state, power control module deactivates selective circuitry within RFID reader 804 or alternatively reduces the output power to a minimum level, and the flow returns to step 902. In an embodiment, RFID reader 804 waits a predetermined time period prior to deactivating the reader circuitry.

### 4.0 Computer Embodiments

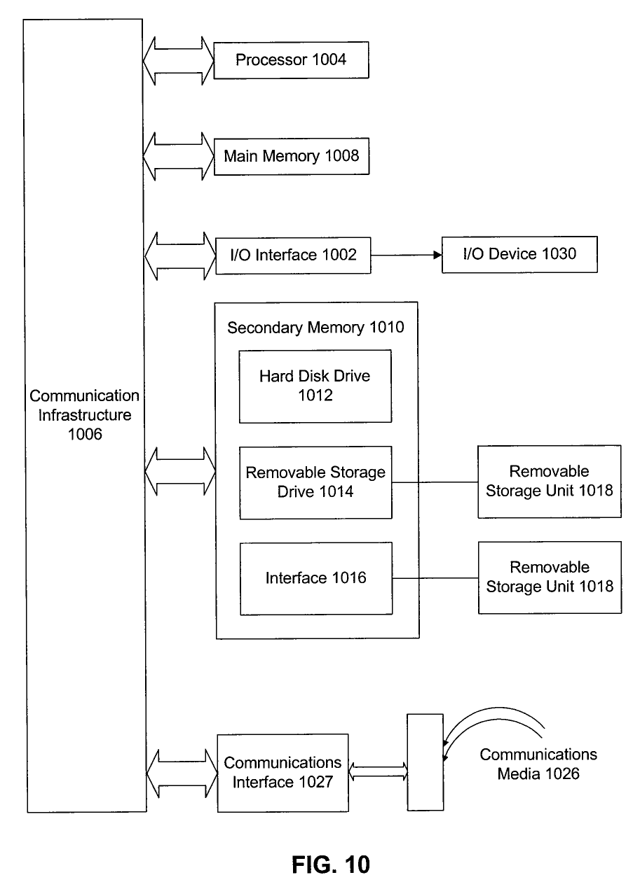

In an embodiment of the present invention, the system and components of the present invention described herein are implemented using well known computer systems, such as a computer system 1000 shown in FIG. 10. Computer system 1000 can be any commercially available and well known computer capable of performing the functions described herein, such as computers available from International Business Machines, Apple, Silicon Graphics Inc., Sun, HP, Dell, Compaq, Digital, Cray, etc. Alternatively, computer system 1000 can be a custom built system.

Computer system 1000 includes one or more processors (also called central processing units, or CPUs), such as a processor 1004. This processor may be a graphics processor in an embodiment of the invention. Processor 1004 is connected to a communication infrastructure or bus 1006. Computer system 1000 also includes a main or primary memory 1008, such as random access memory (RAM). Primary memory 1008 has stored therein control logic (computer software), and data.

Computer system 1000 also includes one or more secondary memory storage devices 1010. Secondary storage devices 1010 include, for example, a hard disk drive 1012 and/or a removable storage device or drive 1014. Removable storage drive 1014 represents, for example, a magnetic tape drive, a compact disk drive, an optical storage device drive, etc.

Removable storage drive 1014 interacts with a removable storage unit 1018. Removable storage unit 1018 includes a computer useable or readable storage medium having stored therein computer software (control logic) and/or data. The logic of the invention as illustrated in various flowcharts above, for example, may be embodied as control logic. Removable storage unit 1018 represents, for example, a floppy disk, a magnetic tape, compact disk, DVD, optical storage disk, or any other computer data storage device. Removable storage drive 1014 reads from and/or writes to removable storage unit 1018 in a well known manner.

Computer system 1000 may also include input/output/display devices 1030, such as monitors, keyboards, pointing devices, etc.

Computer system 1000 further includes a communication or network interface 1027. Network interface 1027 enables computer system 1000 to communicate with remote devices. For example, network interface 1027 allows computer system 1000 to communicate over communication networks or mediums 1026 (representing a form of a computer useable or readable medium), such as LANs, WANs, the Internet, etc. Network interface 1027 may interface with remote sites or networks via wired or wireless connections.

Control logic may be transmitted to and from computer system 1000 via communication medium 1026. More particularly, computer system 1000 may receive and transmit carrier waves (electromagnetic signals) modulated with control logic via communication medium 1026.

Any apparatus or manufacture comprising a computer useable or readable medium having control logic (software) stored therein is referred to herein as a computer program product or program storage device. This includes, but is not limited to, computer system 1000, main memory 1008, hard disk 1012, and removable storage unit 1018. Carrier waves can also be modulated with control logic. Such computer program products, having control logic stored therein that, when executed by one or more data processing devices, can cause such data processing devices to operate as described herein, represent embodiments of the invention.

### 5.0 Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system to manage power levels of a Radio Frequency Identification (RFID) reader, comprising:
a sensing device; and
an RFID reader, wherein the RFID reader includes a power control module configured to modify the output power of the RFID based on a sensed condition.

2. The system of claim 1, wherein the sensing device is a proximity sensor.

3. The system of claim 2, wherein the proximity sensor is an image sensor.

4. The system of claim 2, wherein the proximity sensor is an acoustic sensor.

5. The system of claim 2, wherein the proximity sensor is an optical sensor.

6. The system of claim 1, wherein the sensing device is a motion sensor.

7. The system of claim 1, wherein the sensing device is external to the RFID reader.

8. The system of claim 7, wherein the RFID reader and the sensing device communicate via a Central management System (CMS).

9. A method to manage power consumption by a radio frequency identification (RFID) reader, comprising:
sensing the presence of an object at a distance range from the RFID reader;
turning circuitry within the RFID reader ON if an object is detected; and
turning circuitry within the RFID reader OFF when the object moves out of the distance range.

10. The method of claim 9, wherein the energy signal is transmitted and received acoustically.

11. The method of claim 9, wherein the energy signal is transmitted and received optically.

12. The method of claim 9, further comprising communicating the detected signal to a Central Management System (CMS).

13. The method of claim 9, wherein the sensing comprises:
capturing an image of one or more RFID tagged objects based on reflected ambient light.

14. The method of claim 10, further comprising:
turning circuitry within the reader OFF unitl the presence of the object is no longer sensed.

15. A method to manage power consumption by a radio frequency identification (RFID) reader, comprising:
sensing the motion of the RFID reader;
turning the RFID reader ON if motion is detected; and
turning the RFID reader OFF if motion is not detected for a predetermined period of time.

16. The method of claim 15, wherein said sensing occurs at regular intervals.

17. The method of claim 15, wherein said sensing occurs at random intervals.

18. The method of claim 15, wherein said sensing is performed using an accelerometer.

19. The method of claim 15, wherein the turning the reader OFF comprises selectively deactivating circuitry within the RFID reader.

20. The method of claim 15, further comprising: reading tag data after turning the RFID reader ON and storing the tag data after the reading.
